(19) United States
(12) Patent Application Publication
(10) Pub. No.: US 2023/0229478 A1
(43) Pub. Date: Jul. 20, 2023

(54) ON-BOARDING VIRTUAL INFRASTRUCTURE MANAGEMENT SERVER APPLIANCES TO BE MANAGED FROM THE CLOUD

(71) Applicant: VMWARE, INC., Palo Alto, CA (US)

(72) Inventors: KRISHNENDU GORAI, Banglore (IN); IVAYLO RADOSLAVOV RADEV, Sofia (BG); AKASH KODENKIRI, Bangalore (IN); AMMAR RIZVI, Bangalore (IN); ANIL NARAYANAN NAIR, Bangalore (IN); NIHARIKA NARASIMHAMURTHY, Bangalore (IN)

(21) Appl. No.: 17/695,851

(22) Filed: Mar. 16, 2022

(30) Foreign Application Priority Data
Jan. 14, 2022 (IN) 202241002278

(51) Int. Cl. G06F 9/455; G06F 9/50

(52) U.S. Cl. CPC G06F 9/45558; G06F 9/505; G06F 9/5038; G06F 9/5072; G06F 2009/4557; G06F 2009/45595; G06F 2209/5011; G06F 2009/45579

(57) ABSTRACT

A method of on-boarding a virtual infrastructure management (VIM) server appliance in which VIM software for locally managing a software-defined data center (SDDC) is installed, to enable the VIM server appliance to be centrally managed through a cloud service includes upgrading the VIM server appliance from a current version to a higher version that supports communication with agents of the cloud service, modifying configurations of the upgraded VIM server appliance according to a prescriptive configuration required by the cloud service, and deploying a gateway appliance for running the agents of the cloud service that communicate with the cloud service and the upgraded VIM server appliance.

### RELATED APPLICATION

Benefit is claimed under 35 U.S.C. 119(a)-(d) to Foreign Application Serial No. 202241002278 filed in India entitled “ON-BOARDING VIRTUAL INFRASTRUCTURE MANAGEMENT SERVER APPLIANCES TO BE MANAGED FROM THE CLOUD”, on Jan. 14, 2022, by VMware, Inc., which is herein incorporated in its entirety by reference for all purposes.

### BACKGROUND

In a software-defined data center (SDDC), virtual infrastructure, which includes virtual machines (VMs) and virtualized storage and networking resources, is provisioned from hardware infrastructure that includes a plurality of host computers (hereinafter also referred to simply as “hosts”), storage devices, and networking devices. The provisioning of the virtual infrastructure is carried out by management software, referred to herein as virtual infrastructure management (VIM) software, that communicates with virtualization software (e.g., hypervisor) installed in the host computers.

VIM server appliances, such as VMware vCenter® server appliance, include such VIM software and are widely used to provision SDDCs across multiple clusters of hosts, where each cluster is a group of hosts that are managed together by the VIM software to provide cluster-level functions, such as load balancing across the cluster by performing VM migration between the hosts, distributed power management, dynamic VM placement according to affinity and anti-affinity rules, and high availability (HA). The VIM software also manages a shared storage device to provision storage resources for the cluster from the shared storage device.

For customers who have multiple SDDCs deployed across different geographical regions, and deployed in a hybrid manner, e.g., on-premise, in a public cloud, or as a service, the process of managing VIM server appliances across many different locations has proven to be difficult. These customers are looking for an easier way to monitor their VIM server appliances for compliance with the company policies and manage the upgrade and remediation of such VIM server appliances.

### SUMMARY

One or more embodiments provide cloud services for centrally managing the VIM server appliances that are deployed across multiple customer environments. These cloud services rely on agents running in a cloud gateway appliance also deployed in a customer environment to communicate with the VIM server appliance of that customer environment. To enable this communication in the one or more embodiments, the VIM server appliance undergoes an on-boarding process that includes upgrading the VIM server appliance to a version that is capable of communicating with the agents and carrying out tasks requested by the cloud services, and disabling certain customizable features of the VIM server appliance that either interfere with the cloud services or rely on licenses from third parties. The on-boarding process further includes deploying the VIM server appliance and the cloud gateway appliance on hosts of one of the dusters of the SDDCs, so that hardware resource reservations for these appliances also can be managed by the cloud services.

A method of on-boarding the VIM server appliance, according to an embodiment, includes upgrading a VIM server appliance from a current version to a higher version that supports communication with agents of a cloud service, modifying configurations of the upgraded VIM server appliance according to a prescriptive configuration required by the cloud service, and deploying a gateway appliance for running the agents of the cloud service that communicate with the cloud service and the upgraded VIM server appliance.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 depicts a cloud control plane implemented in a public cloud, and a plurality of SDDCs that are managed through the cloud control plane, according to embodiments.

FIG. 2 depicts a plurality of SDDCs that are managed through the cloud control plane alongside a plurality of SDDCs that are not managed through the cloud control plane.

FIG. 3 is a flow diagram illustrating the steps of the process of on-boarding the VIM server appliance to enable cloud management of the VIM server appliance according to embodiments.

FIGS. 4A-4B are conceptual diagrams illustrating the process of on-boarding a VIM server appliance to enable cloud management of the VIM server appliance according to embodiments.

FIG. 5 is a schematic illustration of a plurality of clusters that are managed by the VIM server appliance.

FIG. 6 is schematic diagram of resource pools that have been set up for one of the clusters that are managed by the VIM server appliance.

### DETAILED DESCRIPTION

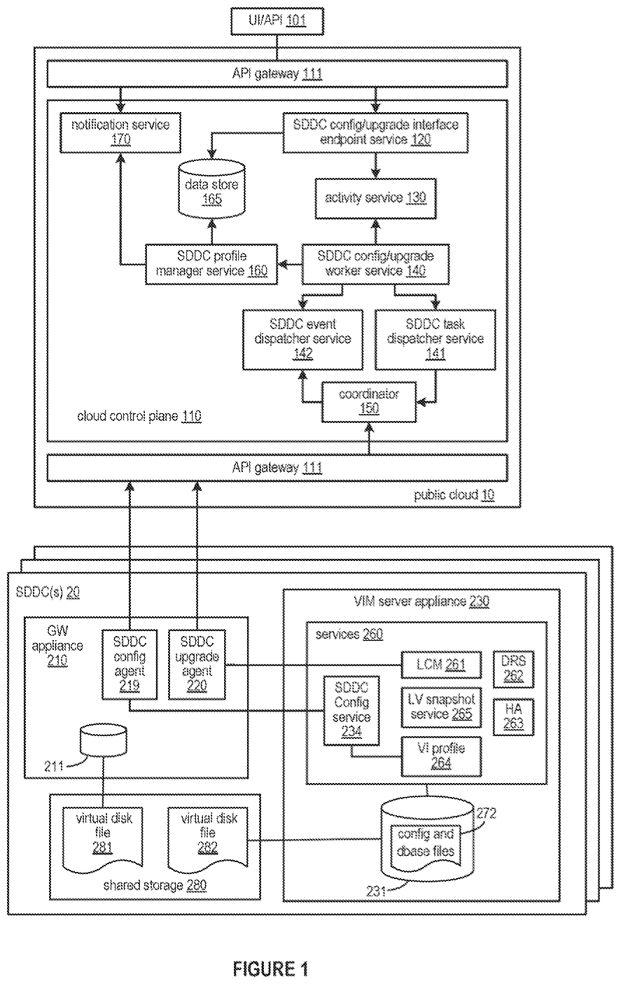

FIG. 1 depicts a cloud control plane 110 implemented in a public cloud 10, and a plurality of SDDCs 20 that are managed through cloud control plane 110. In the embodiment illustrated herein, cloud control plane 110 is accessible by multiple tenants through UI/API 101 and each of the different tenants manage a group of SDDCs through cloud control plane 110. In the following description, a group of SDDCs of one particular tenant is depicted as SDDCs 20, and to simplify the description, the operation of cloud control plane 110 will be described with respect to management of SDDCs 20. However, it should be understood that the SDDCs of other tenants have the same appliances, software products, and services running therein as SDDCs 20, and are managed through cloud control plane 110 in the same manner as described below for SDDCs 20.

A user interface (UI) or an application programming interface (API) that interacts with cloud control plane 110 is depicted in FIG. 1 as UI/API 101. Through UI/API 101, an administrator of SDDCs 20 can issue commands to apply a desired state to SDDCs 20 or to upgrade the VIM server appliance in SDDCs 20.

Cloud control plane 110 represents a group of services running in virtual infrastructure of public cloud 10 that interact with each other to provide a control plane through which the administrator of SDDCs 20 can manage SDDCs 20 by issuing commands through UI/API 101. API gateway 111 is also a service running in the virtual infrastructure of public cloud 10 and this service is responsible for routing cloud inbound connections to the proper service in cloud control plane 110, e.g., SDDC configuration/upgrade interface endpoint service 120, notification service 170, or coordinator 150.

SDDC configuration/upgrade interface endpoint service 120 is responsible for accepting commands made through UI/API 101 and returning the result to UI/API 101. An operation requested in the commands can be either synchronous or asynchronous. Asynchronous operations are stored in activity service 130, which keeps track of the progress of the operation, and an activity ID, which can be used to poll for the result of the operation, is returned to UI/API 101. If the operation targets multiple SDDCs 20 (e.g., an operation to apply the desired state to SDDCs 20 or an operation to upgrade the VIM server appliance in SDDCs 20), SDDC configuration/upgrade interface endpoint service 120 creates an activity which has children activities. SDDC configuration/upgrade worker service 140 processes these children activities independently and respectively for multiple SDDCs 20, and activity service 130 tracks these children activities according to results returned by SDDC configuration/upgrade worker service 140.

SDDC configuration/upgrade worker service 140 polls activity service 130 for new operations and processes them by passing the tasks to be executed to SDDC task dispatcher service 141. SDDC configuration/upgrade worker service 140 then polls SDDC task dispatcher service 141 for results and notifies activity service 130 of the results. SDDC configuration/upgrade worker service 140 also polls SDDC event dispatcher service 142 for events posted to SDDC event dispatcher service 142 and handles these events based on the event type.

SDDC task dispatcher service 141 dispatches each task passed thereto by SDDC configuration/upgrade worker service 140, to coordinator 150 and tracks the progress of the task by polling coordinator 150. Coordinator 150 accepts cloud inbound connections, which are routed through API gateway 111, from SDDC upgrade agents 220. SDDC upgrade agents 220 are responsible for establishing cloud inbound connections with coordinator 150 to acquire tasks dispatched to coordinator 150 for execution in their respective SDDCs 20, and orchestrating the execution of these tasks. Upon completion of the tasks, SDDC upgrade agents 220 return results to coordinator 150 through the cloud inbound connections. SDDC upgrade agents 220 also notify coordinator 150 of various events through the cloud inbound connections, and coordinator 150 in turn posts these events to SDDC event dispatcher service 142 for handling by SDDC configuration/upgrade worker service 140.

SDDC profile manager service 160 is responsible for storing the desired state documents in data store 165 (e.g., a virtual disk or a depot accessible using a URL) and, for each of SDDCs 20, tracks the history of the desired state document associated therewith and any changes from its desired state specified in the desired state document, e.g., using a relational database.

An operation requested in the commands made through UI/API 101 may be synchronous, instead of asynchronous. An operation is synchronous if there is a specific time window within which the operation must be completed. Examples of a synchronous operation include an operation to get the desired state of an SDDC or an operation to get SDDCs that are associated with a particular desired state. In the embodiments, to enable such operations to be completed within the specific time window, SDDC configuration/upgrade interface endpoint service 120 has direct access to data store 165.

As described above, a plurality of SDDCs 20, which may be of different types and which may be deployed across different geographical regions, is managed through cloud control plane 110. In one example, one of SDDCs 20 is deployed in a private data center of the customer and another one of SDDCs 20 is deployed in a public cloud, and all of SDDCs are located in different geographical regions so that they would not be subject to the same natural disasters, such as hurricanes, fires, and earthquakes.

Any of the services of described above (and below) may be a microservice that is implemented as a container image executed on the virtual infrastructure of public cloud 10. In one embodiment, each of the services described above is implemented as one or more container images running within a Kubernetes® pod.

In each SDDC 20, regardless of its type and location, a gateway appliance 210 and VIM server appliance 230 are provisioned from the virtual resources of SDDC 20. In one embodiment, gateway appliance 210 and VIM server appliance 230 are each a VM instantiated in one or more of the hosts of the same cluster that is managed by VIM server appliance 230. Virtual disk 211 is provisioned for gateway appliance 210 and storage blocks of virtual disk 211 map to storage blocks allocated to virtual disk file 281. Similarly, virtual disk 231 is provisioned for VIM server appliance 230 and storage blocks of virtual disk 231 map to storage blocks allocated to virtual disk file 282. Virtual disk files 281 and 282 are stored in shared storage 280. Shared storage 280 is managed by VIM server appliance 230 as storage for the cluster and may be a physical storage device, e.g., storage array, or a virtual storage area network (VSAN) device, which is provisioned from physical storage devices of the hosts in the cluster.

Gateway appliance 210 functions as a communication bridge between cloud control plane 110 and VIM server appliance 230. In particular, SDDC configuration agent 219 running in gateway appliance 210 communicates with coordinator 150 to retrieve SDDC configuration tasks (e.g., apply desired state) that were dispatched to coordinator 150 for execution in SDDC 20 and delegates the tasks to SDDC configuration service 234 running in VIM server appliance 230. In addition, SDDC upgrade agent 220 running in gateway appliance 210 communicates with coordinator 150 to retrieve upgrade tasks (e.g., task to upgrade the VIM server appliance) that were dispatched to coordinator 150 for execution in SDDC 20 and delegates the tasks to a lifecycle manager (LCM) 261 running in VIM server appliance 230. After the execution of these tasks have completed, SDDC configuration agent 219 or SDDC upgrade agent 220 sends back the execution result to coordinator 150.

Various services running in VIM server appliance 230, including VIM services for managing the SDDC, are depicted as services 260. Services 260 include LCM 261, distributed resource scheduler (DRS) 262, high availability (HA) 263, and VI profile 264. DRS 262 is a VIM service that is responsible for setting up resource pools and load balancing of workloads (e.g., VMs) across the resource pools. HA 263 is a VIM service that is responsible for restarting HA-designated virtual machines that are running on failed hosts of the cluster on other running hosts. VI profile 264 is a VIM service that is responsible for applying the desired configuration of the virtual infrastructure managed by VIM server appliance 230 (e.g., the number of clusters, the hosts that each cluster would manage, etc.) and the desired configuration of various features provided by other VIM services running in VIM server appliance 230 (e.g., DRS 262 and HA 263), as well as retrieving the running configuration of the virtual infrastructure managed by VIM server appliance 230 and the running configuration of various features provided by the other VIM services running in VIM server appliance 230. In addition, logical volume (LV) snapshot service 265 is provided to enable snapshots of logical volumes of VIM server appliance 230 to be taken prior to any upgrade performed on VIM server appliance 230, so that VIM server appliance 230 can be reverted to the snapshot of the logical volumes if the upgrade fails. Configuration and database files 272 for services 260 running in VIM server appliance 230 are stored in virtual disk 231.

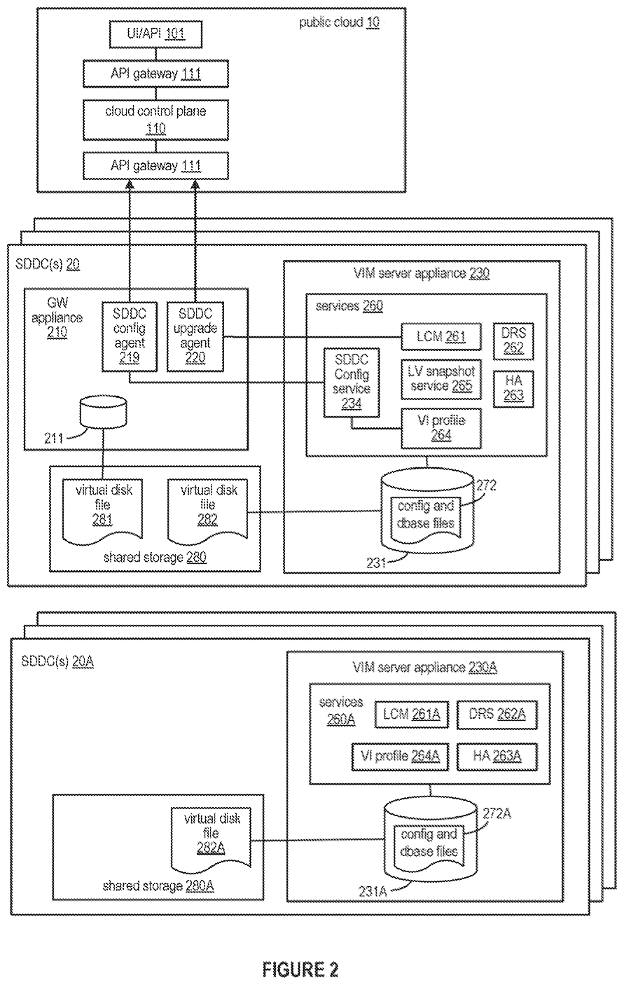

FIG. 2 depicts a plurality of SDDCs 20 that are managed through cloud control plane 110 alongside a plurality of SDDCs 20A that are not managed through cloud control plane 110. In the embodiments, SDDCs 20A are depicted to illustrate the process of on-boarding the VIM server appliances of SDDCs 20A, to enable these VIM server appliances and SDDCs 20A to be managed through cloud control plane 110. Examples of managing the VIM server appliances and SDDCs from the cloud include setting the configuration of all SDDCs of a particular tenant according to a desired state specified in a desired state document retrieved from cloud control plane 110, and upgrading all VIM server appliances of a particular tenant to a new version of the VIM server appliance retrieved from a repository of cloud control plane 110.

VIM server appliance 260A is representative of the state of the VIM server appliances of SDDCs 20A prior to the on-boarding process and include LCM 261A, DRS 262A, HA 263A, and VI profile 264A, each having the same respective functionality as LCM 261, DRS 262, HA 263, and VI profile 264 described above. In addition, virtual disk 231A is provisioned for VIM server appliance 230A, and configuration and database files 272A for services 260A running in VIM server appliance 230A are stored in virtual disk 231A. As described above for virtual disk 231, storage blocks of virtual disks 231A map to storage blocks allocated to virtual disk file 282A stored in shared storage 280A.

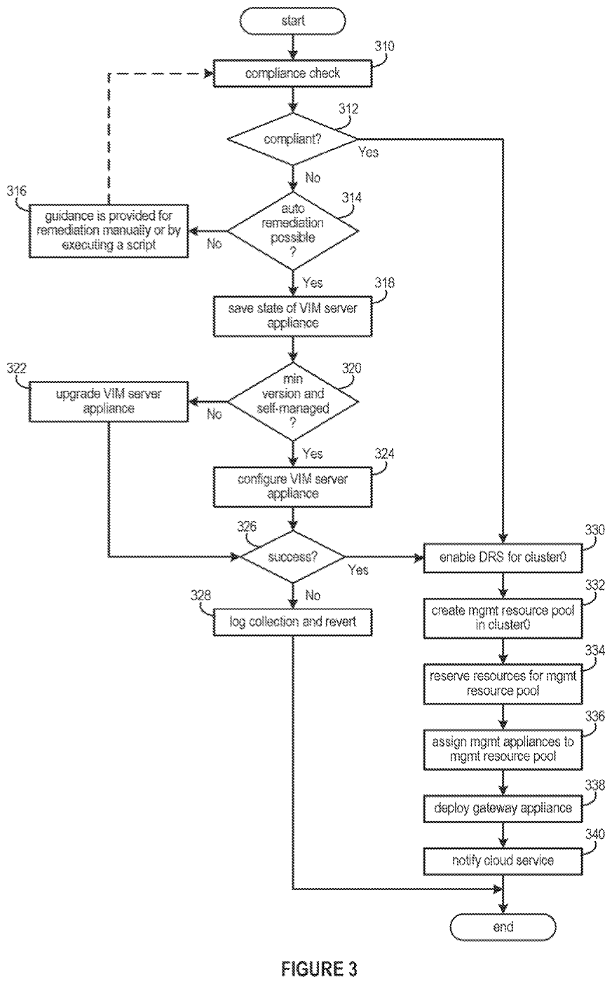

FIG. 3 is a flow diagram illustrating the steps of the process of on-boarding VIM server appliance 230A. The process begins at step 310 in response to a request to on-board VIM server appliance 230A that is made through UI/API 101. At step 312, an on-boarding service in cloud control plane 110 performs a compliance check on VIM server appliance 230A to determine if VIM server appliance 230A can be on-boarded for management by cloud control plane 110 without any modifications. If not, step 314 is executed next.

At step 314, the non-compliant features of VIM server appliance 230A are evaluated for auto-remediation, because there are non-compliant features of VIM server appliance 230A that can be auto-remediated (e.g., by changing a setting in a configuration file or by upgrading VIM server appliance 230A to a higher version) and there are non-compliant features of VIM server appliance 230A that cannot be auto-remediated. If there are any non-compliant features of VIM server appliance 230A that cannot be auto-remediated (step 314, No), guidance is provided through UI/API 101 to perform the remediation either manually or by executing a script (step 316). After remediation is performed manually or by executing a script, the on-boarding process can be requested again through UI/API 101, in which case step 310 is executed again.

If all non-compliant features of VIM server appliance 230A can be auto-remediated, the auto-remediation process begins with the saving of the state of VIM server appliance 230A at step 318. In one embodiment, the auto-remediation process is orchestrated by the on-boarding service and executed by various services of VIM server appliance 230A in response to API calls made by the on-boarding service. At step 320, LCM 261A performs checks on VIM server appliance 230A to determine: (i) if VIM server appliance 230A is at a minimum version that supports communication with agents of cloud control plane 110 or higher; and (ii) if VIM server appliance 230A is self-managed, i.e., VIM server appliance 230A is deployed on a host of a cluster that VIM software of VIM server appliance 230A is managing. If either check fails (step 320, No), VIM server appliance 230A is upgraded to the minimum version or higher at step 322 by carrying out the upgrade process described in U.S. patent application Ser. No. 17/550,388, filed on Dec. 14, 2021, the entire contents of which are incorporated herein.

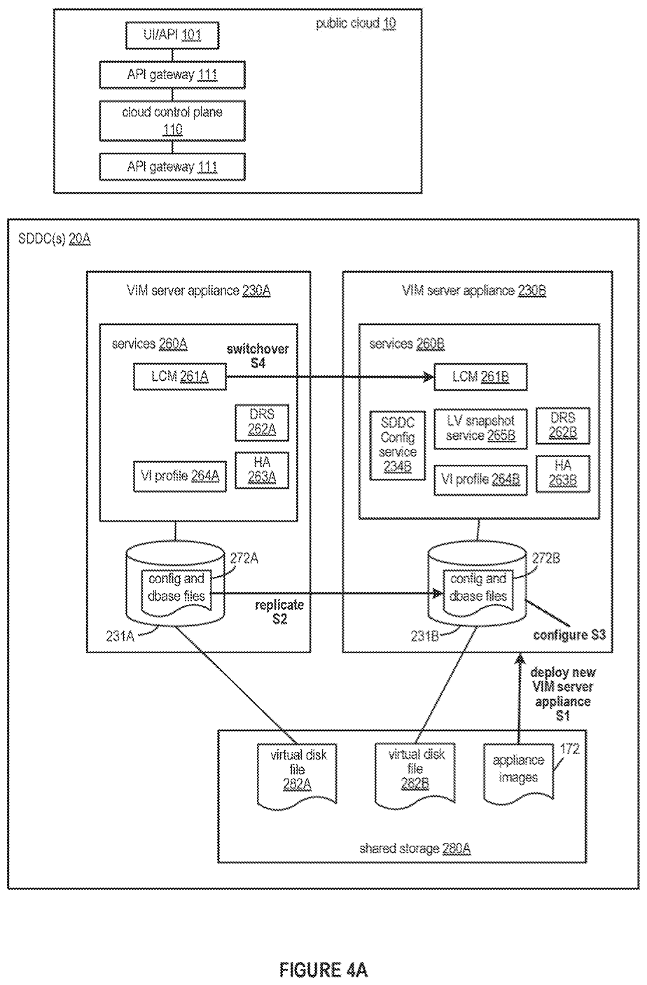

FIG. 4A is a conceptual diagram illustrating the steps of upgrading VIM server appliance 230A from a current version to a higher version that supports communication with agents of cloud control plane 110. In FIG. 4A, VIM server appliance 230A is upgraded to VIM server appliance 230B. The first step of the upgrade (step S1) is deploying an image of a new VIM server appliance (depicted as VIM server appliance 230B), which contains software components that enable communication with agents of cloud control plane 110. These software components are depicted in FIG. 4A as SDDC configuration service 234B (having the same functionality as SDDC configuration service 234 described above) and LCM 261B (having the same functionality as LCM 261 described above). In addition, LV snapshot service 265B is added to the image of VIM server appliance 230B to enable snapshots of logical volumes of VIM server appliance 230B to be taken prior to any upgrade performed on VIM server appliance 230B in the future. Software components that are already included in the image of VIM server appliance 230A (e.g., DRS 262A, HA 263A, and VI profile 264A) are upgraded as necessary to support the on-boarding process described herein. These software components are depicted as DRS 262B, HA 263B, and VI profile 264B in VIM server appliance 230B.

The image of VIM server appliance 230B is deployed from appliance images 172 that have been downloaded into shared storage 280A from an image repository (not shown) of cloud control plane 110. Appliance images 172 also include an image of the gateway appliance that is to be deployed as described below. In addition to deploying the image of VIM server appliance 230B, a virtual disk 231B for VIM server appliance 230B is provisioned in shared storage 280A. As described above for virtual disk 231, storage blocks of virtual disks 231B map to storage blocks allocated to virtual disk file 282B stored in shared storage 280A. As the second step of the upgrade (step S2), configuration and database files 272A that are stored in virtual disk 231A of VIM server appliance 230A are replicated in VIM server appliance 230B and stored in virtual disk 231B as configuration and database files 272B.

The next step after replication is configuration (step S3). During this step, configurations of VIM server appliance 230B are set to those prescribed by cloud control plane 110 for management of VIM server appliance 230B from cloud control plane 110 (as a result of which certain customizable features of VIM server appliance 230B that either interfere with cloud services provided through cloud control plane 110 or rely on licenses from third parties can be disabled). LCM 261B applies the prescribed configurations by invoking application programming interfaces (APIs) of VI profile 264B. For example, if the prescribed configurations require HA services for the VIM server appliance to be disabled, LCM 261B invokes an API of VI profile 264B to update the configuration of HA 263B to disenable HA services for VIM server appliance 230B.

The fourth step of the upgrade is switchover (step S4). During the switchover, LCM 261A stops the VIM services provided by VIM server appliance 230A and LCM 261B starts the VIM services provided by VIM server appliance 230B. In addition, the network identity of VIM server appliance 230A is applied to VIM server appliance 230B so that requests for VIM services will come into VIM server appliance 230B. FIG. 4B represents the state of SDDC 20A after the switchover. In FIG. 4B, VIM server appliance 230A, its services 260A, its virtual disk 231A, configuration and database files 272A stored in virtual disk 231A, and virtual disk file 282A corresponding to virtual disk 231A are depicted in dashed lines to indicate their inactive state.

Returning to step 320, if VIM server appliance 230A is at the minimum version or higher and is self-managed (step 320, Yes), step 324 is executed next. At step 324, configurations of VIM server appliance 230A are set to those prescribed by cloud control plane 110 for management of VIM server appliance 230A from cloud control plane 110. LCM 261A applies the prescribed configurations by invoking APIs of VI profile 264A. For example, if the prescribed configurations require HA services for the VIM server appliance to be disabled, LCM 261A invokes an API of VI profile 264A to update the configuration 263. A to disenable HA services for VIM server appliance 230A.

At step 326, which follows both steps 322 and 324, a check is made to see if auto-remediation succeeded. If not (step 326, No), log of changes made to VIM server appliance 230A since step 318 is collected for debugging and VIM server appliance 230A is reverted back to its saved state. The on-boarding process ends after step 328.

If auto-remediation succeeded (step 326, Yes), a series of steps beginning with step 330 is executed on the VIM server appliance that has been upgraded at step 322 or updated at step 324. In addition, if it is determined at step 312 that VIM server appliance 230A can be on-boarded for management by cloud control plane 110 without any modifications, the series of steps beginning with step 330 is executed on VIM server appliance 230A. Hereinafter, the VIM server appliance on which the series of steps beginning with step 330 is executed and the services provided by this VIM server appliance will be referred to with the letter “B” added to their reference numbers.

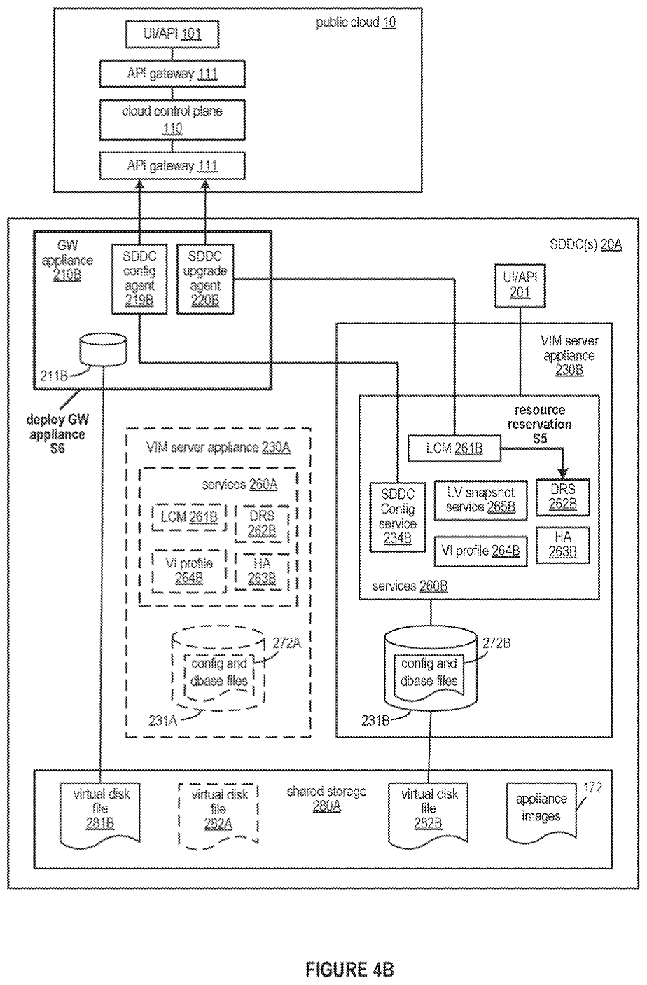

The series of steps that is executed on VIM server appliance 23013 following successful auto-remediation begins with step 330 at which DRS is enabled for one of the clusters of hosts managed by VIM server appliance 230B on which VIM server appliance 230B is deployed. This cluster is referred to herein as a management cluster and is depicted in FIG. 5 as cluster0.

FIG. 5 is a schematic illustration of a plurality of clusters (cluster0, cluster1, . . . , clusterN) managed by VIM server appliance 230B. Each cluster has physical resources allocated to it. The physical resources include a plurality of host computers, storage devices, and networking devices. In FIG. 5, physical resources are depicted in solid lines and virtual resources provisioned from the physical resources are depicted in dashed lines. In particular, cluster0 includes physical hosts 501, 503, and shared storage device 505. In addition, management network 511 and data network 512 of cluster0 are virtual networks provisioned from physical networking devices (e.g., network interface controllers in hosts 501, 503, switches, and routers). The other clusters, cluster1 . . . cluster N, also include physical hosts, shared storage devices, and virtual networks provisioned from physical resources. As further depicted in FIG. 5, the hosts of cluster0 include a host 501 on which VIM server appliance 230B is deployed, and a plurality of workload VM hosts 503 on which workload VMs are deployed.

In addition to VIM server appliance 230B, a gateway appliance (shown in FIG. 4B as gateway appliance 210B) is also deployed on host 501 as will be described below. Hereinafter, the gateway appliances and the VIM server appliances are more generally referred to as “management appliances.” Another example of a management appliance is a server appliance that is responsible for managing virtual networks. In the embodiments illustrated herein, these management appliances are deployed on hosts of cluster0, and hereinafter cluster0 is more generally referred to as a management cluster.

In the embodiments, DRS 262B manages the sharing of hardware resources of each cluster (including the management cluster) according to one or more resource pools. When a single resource pool is defined for a cluster, the total capacity of that cluster (e.g., GHz for CPU, GB for memory, GB for storage) is shared by all of the virtual resources (e.g., VMs) provisioned for that cluster. If child resource pools are defined under the root resource pool of a cluster, DRS 262B manages sharing of the physical resources of the cluster by the different child resource pools. In addition, within a particular resource pool, physical resources may be reserved for one or more virtual machines. In such a case, DRS 262B manages sharing of the physical resources allocated to that resource pool, by the virtual machines and any child resource pools.

Alter DRS services have been enabled for the management cluster at step 330, LCM 261B at step 332 invokes an API of DRS 262B to create a management resource pool for the management appliances in the management cluster. Then, LCM 261B invokes APIs of DRS 262B to reserve hardware resources for the management resource pool (step 334), and to assign the management appliances to the management resource pool (step 336). In FIG. 4B, steps 332, 334, and 336 are represented by step S5. In the embodiments, the actual amount of hardware resources that is reserved for the management appliances is equal to at least the amount of hardware resources required by gateway appliance 210B and the amount of hardware resources required by VIM server appliance 230B. In some embodiments, the actual amount of hardware resources that is reserved for the management appliances is equal to at least the amount of hardware resources required by gateway appliance 210B and two times the amount of hardware resources required by VIM server appliance 230B, so that sufficient hardware resources can be ensured for a migration-based upgrade of VIM server appliance 230B, which requires an instantiation of a second VIM server appliance.

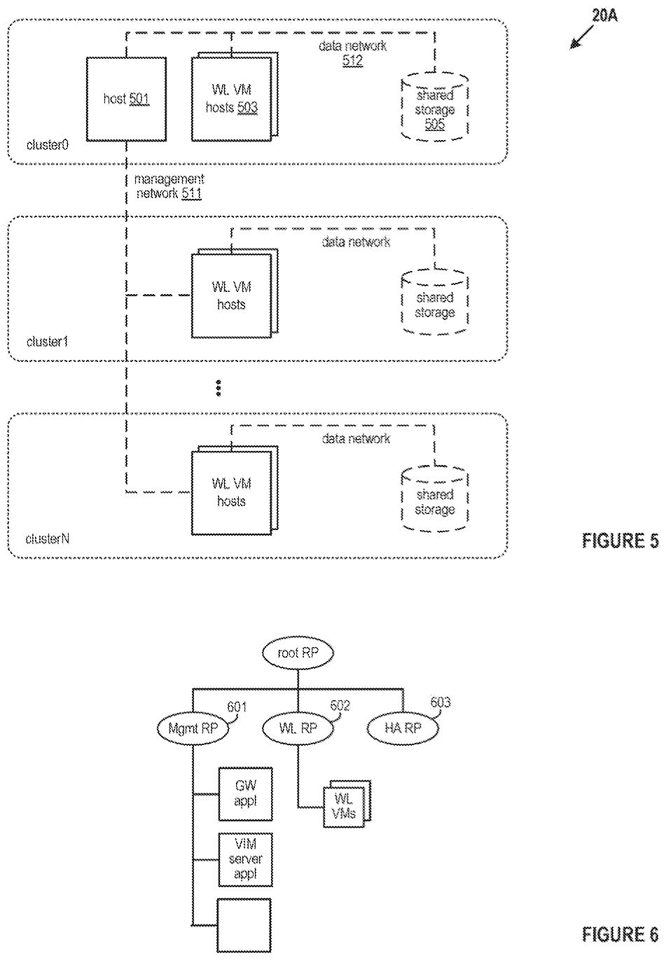

The schematic diagram of FIG. 6 depicts the management cluster as the root resource pool (root RP). Three resource pools, management resource pool 601, workload VM resource pool 602, and high availability resource pool 603, are created as children resource pools of the root resource pool. The children resource pools share the hardware resources of the management cluster according to their hardware resource allocations. The schematic diagram of FIG. 6 also depicts the VMs that are assigned to the different resource pools. The VMs assigned to management resource pool 601 include the gateway appliance and the VIM server appliance. The spare resource that is reserved from management resource pool 601 for the second VIM server appliance that will be needed for migration-based upgrade of the VIM server appliance, is depicted in FIG. 6 as an empty box. The VMs assigned to workload VM resource pool 602 are workload VMs.

At step 338, LCM 261B deploys gateway appliance 210B on host 501 of the management cluster from an image of gateway appliance stored in shared storage 280A as part of appliance images 172. In FIG. 4B, the deployment of gateway appliance 210B is represented by step S6. Gateway appliance 210B includes two agents that communicate with cloud control 110 and VIM server appliance 230B. The first is SDDC configuration agent 219B that communicates with cloud control plane 110 to retrieve SDDC configuration tasks (e.g., task to apply desired state to SDDC 20A) and delegates the tasks to SDDC configuration service 234B running in VIM server appliance 230B. The second is SDDC upgrade agent 220B that communicates with cloud control plane 110 to retrieve upgrade tasks (e.g., task to upgrade VIM server appliance 230B) and delegates the tasks to LCM 261B running in VIM server appliance 230B. After the execution of these tasks have completed, SDDC configuration agent 219B or SDDC upgrade agent 220B sends back the execution result to cloud control plane 110. In addition to deploying the image of gateway appliance 210B, a virtual disk 211B for gateway appliance 210B is provisioned in shared storage 280A. As described above for virtual disk 211, storage blocks of virtual disks 211B map to storage blocks allocated to virtual disk file 281B.

After gateway appliance 210B has been deployed, LCM 261B at step 340 notifies cloud control plane 110 of the deployment through SDDC upgrade agent 220B that the on-boarding process of VIM server appliance 230B has successfully completed so that cloud control plane 110 can begin managing VIM server appliance 230B and SDDC 20A. The on-boarding process ends after step 340.

After the on-boarding process has ended for a tenant so that the tenant can manage all the VIM server appliances of its SDDCs from cloud control plane 110, the tenant can issue instructions through UI/API 101 to monitor the configurations of its SDDCs and report any drift of the configurations from a desired state specified in a desired state document and to either report the drift or automatically remediate the configurations of its SDDCs according to the desired state. In addition, the tenant can perform an upgrade of all the VIM server appliances of its SDDCs through cloud control plane 110 by issuing an upgrade instruction through UI/API 101.

The embodiments described herein may employ various computer-implemented operations involving data stored in computer systems. For example, these operations may require physical manipulation of physical quantities. Usually, though not necessarily, these quantities may take the form of electrical or magnetic signals, where the quantities or representations of the quantities can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of on-boarding a virtual infrastructure management (VIM) server appliance in which VIM software for locally managing a software-defined data center (SDDC) is installed, to enable the VIM server appliance to be centrally managed through a cloud service, said method comprising:
upgrading the VIM server appliance from a current version to a higher version that supports communication with agents of the cloud service;
modifying configurations of the upgraded VIM server appliance according to a prescriptive configuration required by the cloud service; and
deploying a gateway appliance for running the agents of the cloud service that communicate with the cloud service and the upgraded VIM server appliance.

2. The method of claim 1, wherein the SDDC includes a plurality of clusters of hosts that are managed by the VIM software, and the upgraded VIM server appliance and the gateway appliance are deployed on one or more of the hosts of a management cluster that is managed by the VIM software.

3. The method of claim 2, further comprising:
reserving hardware resources of the management cluster for a resource pool that has been created for management appliances that include the upgraded VIM server appliance and the gateway appliance, the hardware resources including at least processor resources of the hosts and memory resources of the hosts; and
assigning the management appliances to the resource pool created for the management appliances,
wherein the management appliances share the hardware resources of the cluster with one or more other resource pools and, after said reserving and said assigning, are allocated at least the hardware resources that have been reserved for the resource pool created for the management appliances.

4. The method of claim 3, wherein
the hardware resources of the cluster reserved for the resource pool for the management appliances satisfy at least the resource requirements of the gateway appliance and two times the resource requirements of the upgraded VIM server appliance.

5. The method of claim 1, wherein the step of upgrading the VIM server appliance to the higher version that supports communication with agents of the cloud service includes:
deploying a new VIM server appliance using an image of the VIM server appliance of the higher version;
replicating configuration and database files of the VIM server appliance of the current version, in the new VIM server appliance; and
after replication, performing a switchover of VIM services that are provided, from the VIM server appliance of the current version to the new VIM server appliance.

6. The method of claim 5, wherein the new VIM server appliance is deployed on a host of one of the clusters that are managed by the VIM software running in the new VIM server appliance.

7. The method of claim 6, wherein
the VIM software provides a distributed resource scheduling (DRS) service and one of the configurations of the upgraded VIM server appliance is modified to enable the DRS service for said one of the clusters.

8. The method of claim 1, wherein
the VIM software provides a high availability service and one of the configurations of the upgraded VIM server appliance is modified to disenable high availability service for the upgraded VIM server appliance.

9. A non-transitory computer readable medium comprising instructions to be executed in a computer system to carry out a method of on-boarding a virtual infrastructure management (VIM) server appliance in which VIM software for locally managing a software-defined data center (SDDC) is installed, to enable the VIM server appliance to be centrally managed through a cloud service, said method comprising:
upgrading the VIM server appliance from a current version to a higher version that supports communication with agents of the cloud service;
modifying configurations of the upgraded VIM server appliance according to a prescriptive configuration required by the cloud service; and
deploying a gateway appliance for running the agents of the cloud service that communicate with the cloud service and the upgraded VIM server appliance.

10. The non-transitory computer readable medium of claim 9, wherein the SDDC includes a plurality of clusters of hosts that are managed by the VIM software, and the upgraded VIM server appliance and the gateway appliance are deployed on one or more of the hosts of a management cluster that is managed by the VIM software.

11. The non-transitory computer readable medium of claim 10, wherein the method further comprises:
reserving hardware resources of the management cluster for a resource pool that has been created for management appliances that include the upgraded VIM server appliance and the gateway appliance, the hardware resources including at least processor resources of the hosts and memory resources of the hosts; and
assigning the management appliances to the resource pool created for the management appliances,
wherein the management appliances share the hardware resources of the cluster with one or more other resource pools and, after said reserving and said assigning, are allocated at least the hardware resources that have been reserved for the resource pool created for the management appliances.

12. The non-transitory computer readable medium of claim 11, wherein
the hardware resources of the cluster reserved for the resource pool for the management appliances satisfy at least the resource requirements of the gateway appliance and two times the resource requirements of the upgraded VIM server appliance.

13. The non-transitory computer readable medium of claim 9, wherein the step of upgrading the VIM server appliance to the higher version that supports communication with agents of the cloud service includes:
deploying a new VIM server appliance using an image of the VIM server appliance of the higher version;
replicating configuration and database files of the VIM server appliance of the current version, in the new VIM server appliance; and
after replication, performing a switchover of VIM services that are provided, from the VIM server appliance of the current version to the new VIM server appliance.

14. The non-transitory computer readable medium of claim 13, wherein the new VIM server appliance is deployed on a host of one of the clusters that are managed by the VIM software running in the new VIM server appliance.

15. A computer system including a processor programmed to carry out a method of on-boarding a virtual infrastructure management (VIM) server appliance in which VIM software for locally managing a software-defined data center (SDDC) is installed, to enable the VIM server appliance to be centrally managed through a cloud service, said method comprising:
upgrading the VIM server appliance from a current version to a higher version that supports communication with agents of the cloud service;
modifying configurations of the upgraded VIM server appliance according to a prescriptive configuration required by the cloud service; and
deploying a gateway appliance for running the agents of the cloud service that communicate with the cloud service and the upgraded VIM server appliance.

16. The computer system of claim 15, wherein the SDDC includes a plurality of clusters of hosts that are managed by the VIM software, and the upgraded VIM server appliance and the gateway appliance are deployed on one or more of the hosts of a management cluster that is managed by the VIM software.

17. The computer system of claim 16, wherein the method further comprises:
reserving hardware resources of the management cluster for a resource pool that has been created for management appliances that include the upgraded VIM server appliance and the gateway appliance, the hardware resources including at least processor resources of the hosts and memory resources of the hosts; and
assigning the management appliances to the resource pool created for the management appliances,
wherein the management appliances share the hardware resources of the cluster with one or more other resource pools and, after said reserving and said assigning, are allocated at least the hardware resources that have been reserved for the resource pool created for the management appliances.

18. The computer system of claim 15, wherein the step of upgrading the VIM server appliance to the higher version that supports communication with agents of the cloud service includes:
deploying a new VIM server appliance using an image of the VIM server appliance of the higher version;
replicating configuration and database files of the VIM server appliance of the current version, in the new VIM server appliance; and
after replication, performing a switchover of VIM services that are provided, from the VIM server appliance of the current version to the new VIM server appliance.

19. The computer system of claim 18, wherein
the VIM software provides a distributed resource scheduling (DRS) service and one of the configurations of the upgraded VIM server appliance is modified to enable the DRS service for one of the clusters managed by the VIM software running in the new VIM server appliance, on which the new VIM server appliance is deployed.

20. The computer system of claim 15, wherein
the VIM software provides a high availability service and one of the configurations of the upgraded VIM server appliance is modified to disenable high availability service for the upgraded VIM server appliance.
